(19) United States
(12) Patent Application Publication
(10) Pub. No.: US 2015/0069691 A1
(43) Pub. Date: Mar. 12, 2015

(54) ROTARY CUTTING MAT

(71) Applicant: Chi-Jen CHEN, Xihu (TW)

(72) Inventor: Chi-Jen CHEN, Xihu (TW)

(21) Appl. No.: 14/019,727

(22) Filed: Sep. 6, 2013

(51) Int. Cl. A47J 47/00; B26D 7/20

(52) U.S. Cl. CPC A47J 47/005; B26D 7/20
USPC 269/55

(57) ABSTRACT

A rotary cutting mat is provided wherein the coupling portion penetrates the axle hole of the bottom board, and the end surface of the coupling portion is mated with the mating surface of the cutting mat, such that the expanded portion is located into the expanded opening of the bottom board, and also abutted onto the abutting wall. In this way, the bottom board is securely limited at one side of the cutting mat, such that the bottom board and cutting mat are abutted tightly. Hence, no disengagement or peeling-off may occur no matter how the user intends to adjust or overturn the cutting mat, thus improving greatly the stability of rotary adjustment, ease-of-operation and applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable

REFERENCE TO AN APPENDIX SUBMITTED ON COMPACT DISC

Not applicable.

### BACKGROUND OF THE INVENTION

1. Field of the Invention

The present invention relates generally to a rotary cutting mat, and more particularly to an innovative one which is designed to avoid disengagement or peeling-off during rotary adjustment.

2. Description of Related An Including Information Disclosed Tinder 37 CFR 1.97 and 37 CFR 1.98.

When cutting objects on a table (e.g. cutting paper by an art cutter), a cutting mat is often cushioned to avoid damage of the table surface and facilitate the cutting action.

Traditionally, the cutting mat is often formed by a board of a certain thickness, and some marking lines showing the dimension and meshes are often drawn on the surface of the cutting mat as a benchmark for cutting objects. In response to diversified user demands, a cutting mat for flexible adjustment of angle has been developed. Referring to FIG. 1, the cutting mat 01 comprises an upper board 02 and a lower board 03, of which an axle hole 04 is opened at the center upper board 02, and a flanged shaft 05 is set on the lower board 03 opposite to the axle hole 04, so that the axle hole 04 of the upper board 02 is sleeved onto the flanged shaft 05 of the bottom board 03. In this way, the upper and lower boards 02, 03 can be superimposed in a rotary state. When the object is placed on the upper board 02 and supported by the lower board 03, the angle can be adjusted by rotating the upper board 02.

Despite the available adjustment functions of said cutting mat 01, the upper board 02 is sleeved onto the flanged shaft 05 of the bottom board 03 only via the axle hole 04 without any limitation structure, so the superimposition state of the upper and lower boards 02, 03 is not very stable. When rotating the upper board 02 or removing or fetching the objects during the cutting process, the upper and lower boards 02, 03 are vulnerable to disengagement and peeling-off, leading to great inconvenience and much lower applicability.

Thus, to overcome the aforementioned problems of the prior art, it would be an advancement if the an to provide an improved, structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention allows the coupling portion to penetrate the axle hole of the bottom board, and the end surface of the coupling portion is mated with the mating surface of the cutting mat, such that the expanded portion is located into the expanded opening of the bottom board, and also abutted onto the abutting wall. In this way, the bottom board is securely limited at one side of the cutting mat, such that the bottom board and cutting mat are abutted tightly. Hence, no disengagement or peeling-off may occur no matter how the user intends to adjust or overturn the cutting mat, thus improving greatly the stability of rotary adjustment, ease-of-operation and applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of a conventional cutting mat.

FIG. 2 is an exploded perspective view of the present invention.

FIG. 3 is a perspective view of the present invention.

FIG. 4 is a partially enlarged view of the present invention.

FIG. 5 is a rotary adjustment view of the present invention.

FIG. 6 is a schematic view of the present invention wherein the cutting mat is overturned.

### DETAILED DESCRIPTION OF THE INVENTION

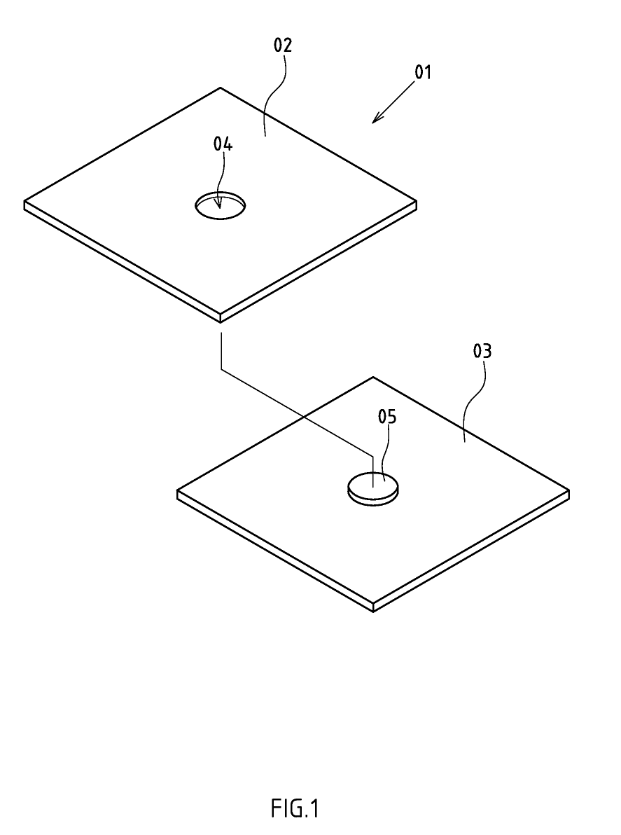

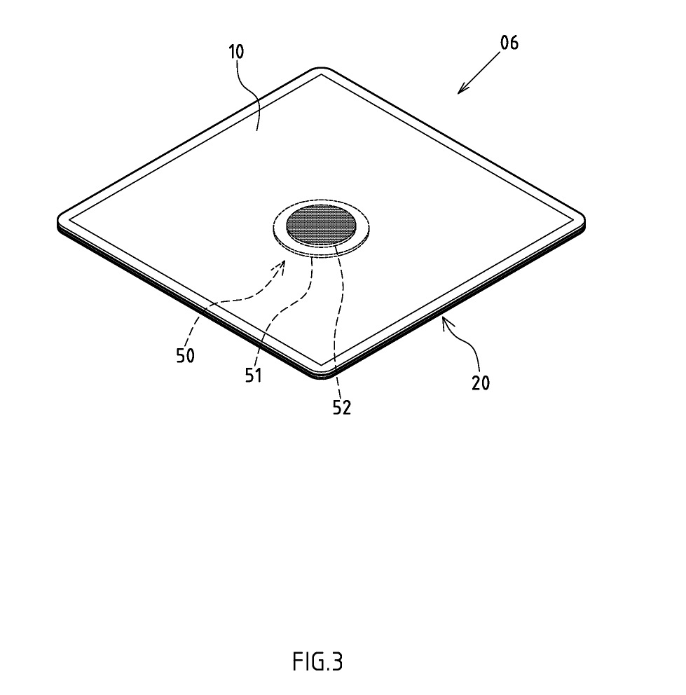

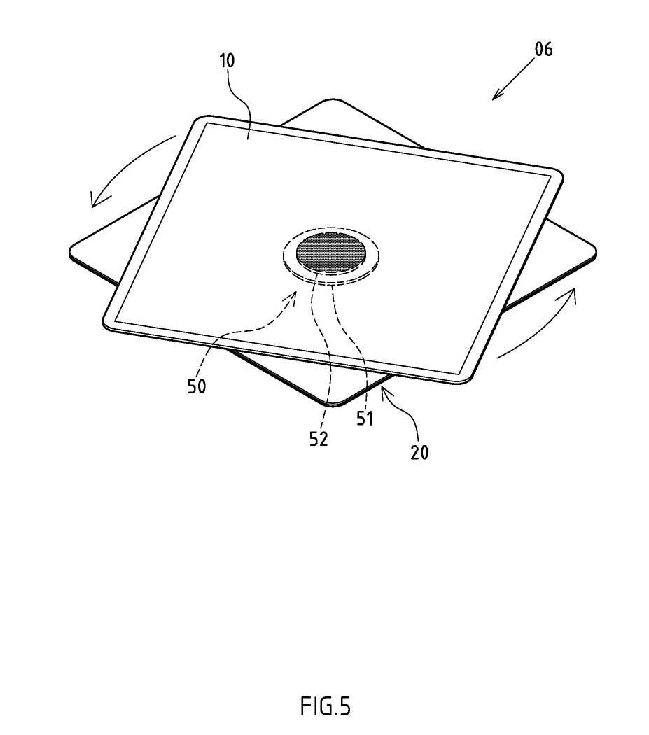

FIGS. 1-5 depict preferred embodiments of the rotary cutting mat of the present invention, which, however, are provided for only explanatory objective.

Said rotary cutting mat 06 comprises a cutting mat 10, fabricated into a faceted pattern to define a mating surface 11. A marker of predefined pattern is set on the surface of said cutting mat 10 as a reference for cutting.

A bottom board 20 is fabricated into a faceted pattern. An axle hole 21 is opened on the predefined position of the bottom board, and vertically connected to two side surfaces of the bottom board 20. Said axle hole 21 is opened on the center of the bottom board 20.

An expanded opening 30 is formed on one side surface of the bottom board 20 opposite to the mating, surface 11 of the cutting mat 10, and located coaxially with the axle hole 21, such that the expanded opening 30 and axle hole 21 are sectionally formed into a stepped pattern. Of which, the external diameter of the expanded opening 30 must be bigger than the axle hole 21.

An abutting wall 40 is formed on the wall surface between the expanded opening 30 and axle hole 21.

A rotary mating member 50 comprises of an expanded portion 51 and a coupling portion 52. Of which, the external diameter of the expanded portion 51 must be bigger than that of the coupling portion 52, such that the rotary mating member 50 is sectionally formed into a stepped pattern. Of which, the coupling portion 52 can penetrate the axle hole 21 of the bottom board 20, and the end surface of the coupling portion 52 is mated with the mating surface 11 of the cutting mat 10 (by means of adhesion, ultrasonic fusion, infrared, fusion or vibration frictional fusion), such that the expanded portion 51 is located into the expanded opening 30 of the bottom board 20, and also abutted onto the abutting wall 40. In this way, the bottom board 20 is securely limited at one side of the cutting mat 10, such that the bottom board 20 and cutting mat 10 are abutted tightly. Next, the cutting mat 10 and bottom board 20 could rotate correspondingly by taking the coupling portion 52 of the rotary mating member 50 as a rotary pivot. Besides, the thickness of the expanded portion 51 of the rotary mating member 50 must be smaller than the soft lower board 23 of the bottom board 20. When the end surface of the coupling portion 52 is mated with the mating surface 11 of the cutting mat 10, the expanded portion 51 can be embedded into the expanded opening 30, and a spacing is kept between the expanded portion Si of the rotary mating member 50 and the bottom of the bottom board 20.

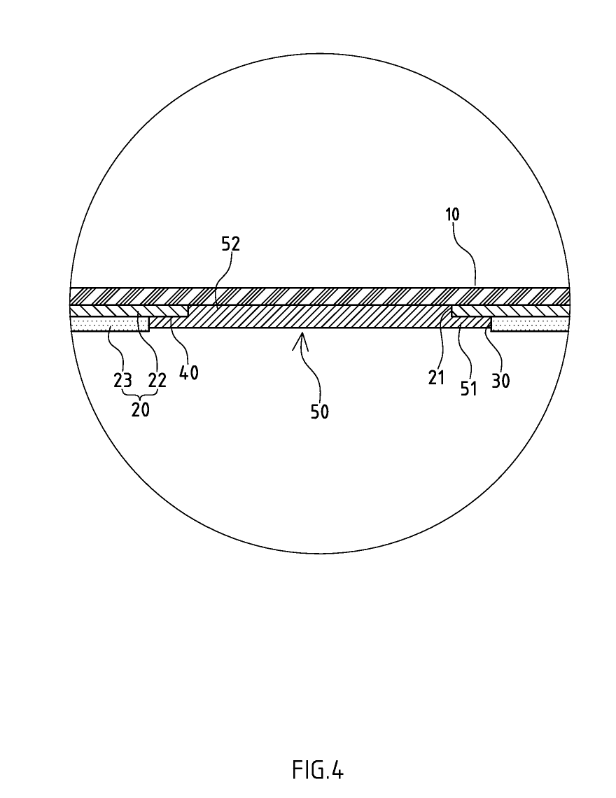

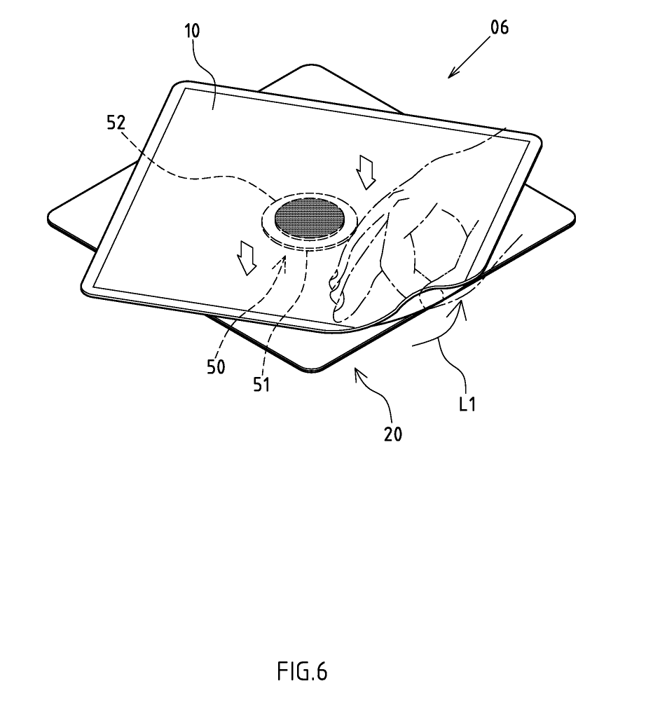

Based upon the above-specified structural design, the present invention allows one to place a preset object onto the cutting mat 10 with the support of the bottom board 20. As the expanded portion 51 of the rotary mating member 50 can be abutted onto the abutting wall 40 formed between the expanded opening 30 and axle hole 21, the bottom board 20 is securely limited at one side of the cutting mat 10. Hence, no disengagement or peeling-off may occur no matter how the user intends to adjust the cutting mat 10. Referring also to FIGS. 4, 6, the cutting mat 10 is not disengaged from the bottom board 20 even if the cutting mat 10 (indicated by arrow L1) is overturned when removing or fetching the object; as a spacing is kept between the expanded portion 51 of the rotary mating member 50 and the bottom of the bottom board 20, when the bottom board 20 is placed on the table surface, the space between the expanded portion 51 and the table surface could generate a vacuum pressure. When the cutting mat 10 is overturned by the user, the rotary mating member 50 is pulled upwards from the center of the bottom board 20(shown in FIG. 6). In such a case, vacuum adsorption effect could be generated between the bottom board 20 and table surface in the same way of sucking disc, so that the rotary cutting mat 06 could be placed more robustly to improve greatly the stability of rotary adjustment, ease-of-operation and applicability.

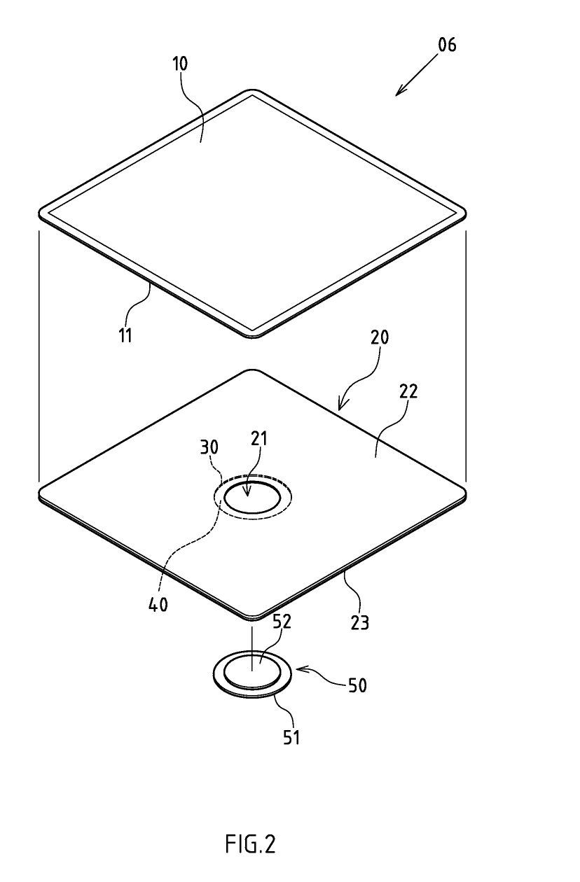

Referring to FIGS. 2 and 4, the bottom board 20 comprises of a solid upper board 22 and a soft lower board 23, of which the solid upper board 22 can be located correspondingly with the mating surface 11 of the cutting mat 10. Said axle hole 21 is opened on the solid upper board 22, while the expanded opening 30 is formed coaxially opposite to the soft lower board 23 and axle hole 21.

Of which, the solid upper board 22 is made of PVC, PP or PS solid plastics. The soft lower board 23 is made of soft foamed material such as soft foam, such that the bottom board 20 could be placed with non-sliding effect via the help of the soft lower board 23.

1. A rotary cutting mat comprising:
a cutting mat, fabricated into a faceted pattern to define a mating surface;
a bottom board, fabricated into a faceted patterns, an axle hole is opened on the predefined position of the bottom board, and vertically connected to two side surfaces of the bottom board;
an expanded opening, formed on one side surface of the bottom board opposite to the mating surface of the cutting mat, and located coaxially with the axle hole, such that the expanded opening and axle hole are sectionally formed into a stepped pattern; of which the external diameter of the expanded opening must be bigger than the axle hole;
an abutting wall, formed on the wall surface between the expanded opening and axle hole;
a rotary mating member, comprising of an expanded portion and a coupling portion; of which the external diameter of the expanded portion must be bigger than that of the coupling portion, such that the rotary mating member is sectionally formed into a stepped pattern; of which the coupling portion can penetrate the axle hole of the bottom board and the end surface of the coupling portion is mated with the mating surface of the cutting mat, such that the expanded portion is located into the expanded opening of the bottom board, and also abutted onto the abutting wall; in this way, the bottom board is securely limited at one side of the cutting mat, such that the bottom board and cutting mat are abutted tightly; next, the cutting mat and bottom board could rotate correspondingly by taking the coupling portion of the rotary mating member as a rotary pivot.

2. The structure defined in claim 1, wherein said bottom board comprises of a solid upper board and a soft lower board, of which the solid upper board can be located correspondingly with the mating surface of the cutting mat; and said axle bole is opened on the solid upper board, while the expanded opening is formed coaxially opposite to the soft lower board and axle hole.

3. The structure defined in claim 2, wherein said solid upper board is made of PVC, PP or PS solid plastics; the soft lower board is made of soft foamed material, such that the bottom board could be placed with non-sliding effect via the help of the soft lower board.

4. The structure defined in claim 3, wherein the thickness of the expanded portion of the rotary mating member must be smaller than the soft lower board of the bottom board; when the end surface of the coupling portion is mated with the mating surface of the cutting mat, the expanded portion can be embedded into the expanded opening.

5. The structure defined in claim 1, wherein the end surface of the coupling portion is mated with the mating surface of the cutting mat by means of adhesion, ultrasonic fusion, infrared fusion or vibration frictional fusion.
